(19) United States
(12) Patent Application Publication
(10) Pub. No.: US 2005/0096924 A1
(43) Pub. Date: May 5, 2005

(54) Solution network knowledge management system

(76) Inventors: James Hunter Enis, Round Rock, TX (US); Larry W. White, Austin, TX (US)

Correspondence Address: Stephen A. Terrile;HAMILTON & TERRILE, LLP, PO Box 203518, Austin, TX, 78720, US

(21) Appl. No.: 10/697,173

(22) Filed: Oct. 30, 2003

(51) Int. Cl. G06F 17/60

(52) U.S. Cl. 705/1

(57) ABSTRACT

A method for creating knowledge in a solution network. The method includes generating knowledge for a solution network based upon an interaction with a user of the solution network and saving the knowledge for the solution network while interacting with the user.

### BACKGROUND OF THE INVENTION

1. Field of the Invention

The present invention relates to the field of customer support and more particularly to knowledge management systems for use with customer support systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems such as home and business computers, the provision of timely and efficient diagnostic, support, and maintenance services to end users has become an important issue for manufacturers and sellers of computer systems. It is not uncommon for end users, especially new users, or experienced users attempting to add or reconfigure existing systems, to experience difficulties with their systems. For example the system might lock up (often referred to as freezing up or hanging). Also for example, a peripheral of the computer system, such as a hard drive, disk drive, or printer, may not function properly. In other cases, the computer system may not recognize the peripheral. The solution to these sorts of problems may range from simply turning on power to the affected peripheral, reconnecting the affected peripheral, reconfiguring the computer system hardware or software, or installing a necessary software patch for the affected peripheral.

To diagnose and correct an issue, users typically have had to consult user's manuals that were included with the purchase of the system or peripheral. These manuals typically include troubleshooting tables or guides that attempt to diagnose a user's problem on the basis of symptoms recognized by the user. The effectiveness of the user's manual in assisting the users in identifying and correcting the problems encountered depends in large part on the skill of the computer user and the clarity and completeness of the user's manual. An inexperienced user may have difficulty in locating the source of the problem and in following the often confusing instructions in the user's manual. Moreover, user's manuals are often deficient in that they do not address every difficulty encountered by the user.

As an alternative or in addition to consulting a user's manual, a user experiencing difficulty with a system may consult diagnostic and support software stored locally on the system. The effectiveness of locally stored diagnostic software is limited in that the software programs generally display text files that have information similar to that found in user's manuals. As a result, users attempting to diagnose computer system problems through locally stored software programs face limitations similar to those faced by users attempting to diagnose system problems through a user's manual.

As another alternative, users may have access to a support or help line. A support or help line requires that the user contact a support technician or specialist at a central site. The support technician listens to the user's symptoms and attempts to diagnose the problem. This process often involves the support technician stepping the user through a series of diagnostic tests. If appropriate, the support technician may provide the user with instructions or tips for correcting the problem. The effectiveness of interpersonal diagnostic and support services of this sort depends in large part on the skill of the user being assisted. Regardless of the skill and knowledge of the support technician, the user will nevertheless have to describe correctly the problem being experienced, assist the support technician in diagnosing the problem, and perform the fix or correction suggested by the support technician.

One issue relating to the support system relates to the knowledge base that is accessed by the support technician or user to address the user's issue. Creating applicable knowledge within a technical environment to be used by a support system may be cumbersome and often leads to irrelevant knowledge creation. In known environments, engineers and technical writers generate technical knowledge while disengaged from the customer or end user. Without accountability and direct exposure to the customer's perceptions and issues, knowledge creation may be difficult to locate or may be irrelevant.

### SUMMARY OF THE INVENTION

In accordance with the present invention, a knowledge management system is provided which streamlines resource usage and enhances knowledge mining capabilities by eliminating the need for a third part or disconnected content creation group. The system creates content applicable to the customer and business needs by integrating the content creation process and the call center technician phone intake process.

In one embodiment, the invention relates to a method for creating knowledge in a solution network. The method includes generating knowledge for a solution network based upon an interaction with a user of the solution network and saving the knowledge for the solution network while interacting with the user.

In another embodiment, the invention relates to a system for creating knowledge in a solution network. The system includes means for generating knowledge for a solution network based upon an interaction with a user of the solution network and means for saving the knowledge for the solution network while interacting with the user.

In another embodiment, the invention relates to a solution network which includes a technician interface, a repository coupled to the technician interface, and an information broker coupled to the technician interface and to the repository. The information broker determines a best answer for the user based upon information provided by the user. The technician interface enables generation of a knowledge based upon an interaction with a user of the solution network. The repository stores knowledge relating to troubleshooting solutions. The knowledge relating to troubleshooting solutions includes knowledge based upon the interaction with the user. The knowledge based upon the interaction with the user is stored in the repository while interacting with the user

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a solution environment.

FIG. 2 shows a block diagram of a solution network.

FIG. 3 shows a flow chart of the operation of a call in the solution network.

FIG. 4 shows a flow chart of the operation of a knowledge management system of the solution network.

FIG. 5 shows a block diagram of an input output process for content creation.

### DETAILED DESCRIPTION

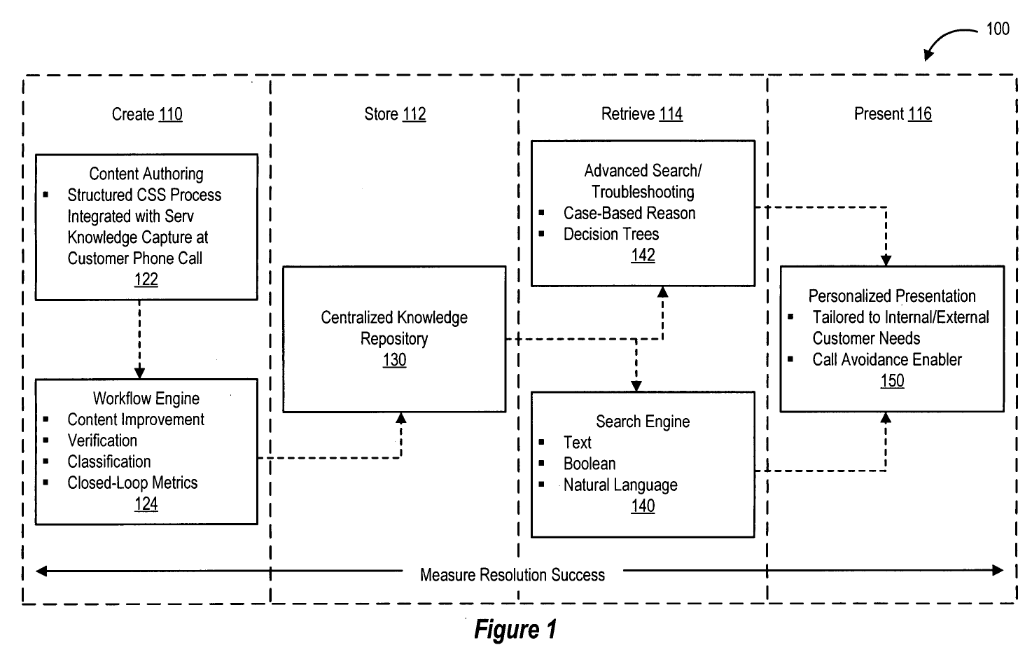

Referring to FIG. 1, a block diagram of the solution environment 100 is shown. More specifically, the solution environment 100 includes a create portion 110, a store portion 112, a retrieve portion 114 and a present portion 116.

The create portion 110 provides an environment in which knowledge is created. More specifically, the create portion 110 includes a content authoring portion 122 and a workflow engine portion 124. The content authoring portion provides a structured customer service and support (CSS) process which is integrated with a solution network server. The content authoring portion 122 also includes a knowledge capture portion which enables knowledge capture during communication with a customer. The workflow engine portion 124 provides a content improvement function, a knowledge verification function, a knowledge classification function as well as closed loop metrics for knowledge creation.

The store portion 112 provides the environment in which knowledge is stored. More specifically, the store portion 112 includes a centralized knowledge repository 130 in which knowledge that is created in the create portion 110 is stored.

The retrieve portion 114 provides the environment in which knowledge is retrieved. More specifically, the retrieve portion includes a search engine 140 in which various types of searches may be performed on the centralized knowledge repository 130. The searches may be in the form of, e.g, text searches, Boolean searches or natural language searches, etc. The retrieve portion also includes an advanced search and troubleshooting portion 142 which provides case based reason function as well as a decision tree function.

The present portion 116 provides the environment in which support knowledge is presented to a customer. More specifically, the present portion 116 provides a personalized presentation 150 of support knowledge. This information may be tailored to the internal or external customer needs. Providing a personalized presentation 150 becomes a call avoidance enabler in that a personalized presentation may enable a customer to obtain a answer to a problem without the need for a specific call to customer support.

The solution environment streamlines resource usage and enhances knowledge mining capabilities by eliminating the need for a third party or disconnected content creation group. The environment enables content creation applicable to the customer and business needs by integrating the content creation process and the call center technician phone intake process. The technical information is removed from a customer management tool and placed in a repository that can be used by other technicians. The environment thus enables continual use which allows the technical repository to evolve and grow while focusing knowledge mining on confirmed applicable incidents as compared to a perceived need.

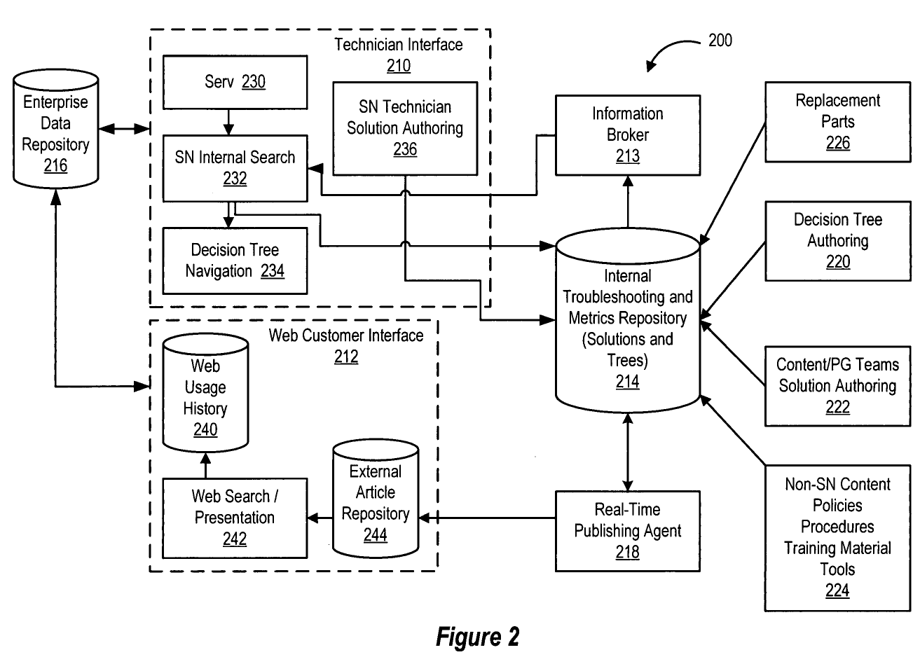

Referring to FIG. 2, a block diagram of a solution network 200 which instantiates the solution environment is shown. More specifically, the solution network 200 includes a technician interface module 210, a customer interface module 212, an information broker 213, an internal repository 214, an enterprise data repository 216, a real time publishing agent 218, a decision tree authoring module 220, a content/PG teams solution authoring module 222, a Non-solution network (Non-SN) content module 224 and a replacement parts module 226. The technician interface module 210 is coupled to the enterprise data repository 216, to the customer interface module 212 and to the information broker 213 as well as to the internal repository 214. The internal repository 214 is coupled to the information broker 213 and the real time publishing agent 218 as well as the decision tree authoring module 220, the content/PG teams solution authoring module 222, the Non-solution network (Non-SN) content module 224 and the replacement parts module 226. The real time publishing agent 218 is coupled to the customer interface 212.

The technician interface module 210 provides the user interface function between the technician and the solution network system 200. The customer interface module 212 provides the interface function for customers to the solution network system 200. The information broker 213 accesses information from the internal repository 214 and provides this information to the technician interface 210. The internal repository 214 provides a repository for troubleshooting solutions (both solutions and solution trees) as well as metrics relating to the solution network. The troubleshooting solutions may include articles, decision trees, and policies. The information broker 213 determines a best answer for a user based upon the user's answers to questions presented by the technician. The solution may be an action, such as rebooting the customer system, or the solution may be an actual part that needs to be replaced on the customer system. In the case of a part, the part number may be listed as the solution within the internal repository 214.

The enterprise data repository 216 is a customer database which includes historics on a customer including what system the customer has purchased, the components included with the system, profile history (i.e., contact information) as well as prior service history, prior rendered solutions and prior web support activity. Linking this customer information with the solution network 200 enables generating a solution faster and with fewer questions to the customer. Additionally, providing the component information to the solution network 200 enables solutions to be rendered that may be component specific. Additionally, maintaining service history on a customer basis enables the solution network 200 to tailor customer specific solutions as well as monitoring whether a particular customer is trying to take advantage of the service provider by obtaining excess replacement components.

The real time publishing agent 218 enables the solution network 200 to release knowledge immediately while the solution network 200 is running. Thus, technicians and customers have access to solutions stored within the repository 214 as soon as the solution is released, without having to wait for a new publish cycle to occur.

The technician interface 210 includes a server module 230, an internal search module 232, a decision tree navigation module 234 and a SN technician solution authoring module 236. The server module 230 provides the service on which the technician interface 210 resides. The SN internal search module 232 receives customer described issue and searches the internal repository 214 for possible solutions. The search module 232 systematically converts how a customer describes an issue into searchable keywords. For example, if a customer call and informs the technician that the customer system will not turn on, the search module may convert this to a technical search for solutions relating to a “No Power on Self Test (POST)” condition. The decision tree navigation module 234 controls the way that branches on a solution network decision tree are rendered. The technician solution authoring module 236 enables a technician to modify or augment a solution provided by the repository in real time (i.e., provide the modification or augmentation to the repository while the technician is interacting with a customer). A particular line of business can see these augmentations either immediately or after release from incubation. The level of incubator at which the line of business is notified is customizable depending on the desires of each line of business.

The customer interface 212 is, for example a web customer interface, which is accessible via the internet. The customer interface 212 includes a web usage history module 240, a web search and presentation module 242 and an external article repository 244. The web usage history module 240 maintains a history of the interaction between a customer and the solution network 200. This history is maintained so that if an issue is forwarded from the customer interface 212 to the technician interface 210, the technician can easily determine what questions or answers have already been tried by the user when attempting self-help via the customer interface 212 before enlisting technician assisted support. The web search/presentation module 242 is the module with which the customer interacts when accessing the customer interface 212. The external article repository 244 is a repository of documents that have been released for public access.

The decision tree authoring module 220 stores information within the repository 214 which enables knowledge to be linked together in a process oriented fashion. The content/PG teams solution authoring module 222 enables the authoring of stand alone knowledge solutions and applies the appropriate attributes to this knowledge. The Non-solution network (Non-SN) content module 224 stores information regarding policies and procedures within the repository 214. For example, a particular customer might have certain associated business policies that a technician might be expected to apply. The Non-SN content module 224 thus essentially applies a filter to particular customer situations. The Non-SN content module 224 also includes training material for training support technicians. This training material includes extra support detail than is provided to technicians who are interacting with customers. The Non-SN content module 224 also provides a conduit into other support tools that might not have been stored within the repository 214. The replacement parts module 226 develops solutions relating to which replacement parts are associated with particular systems.

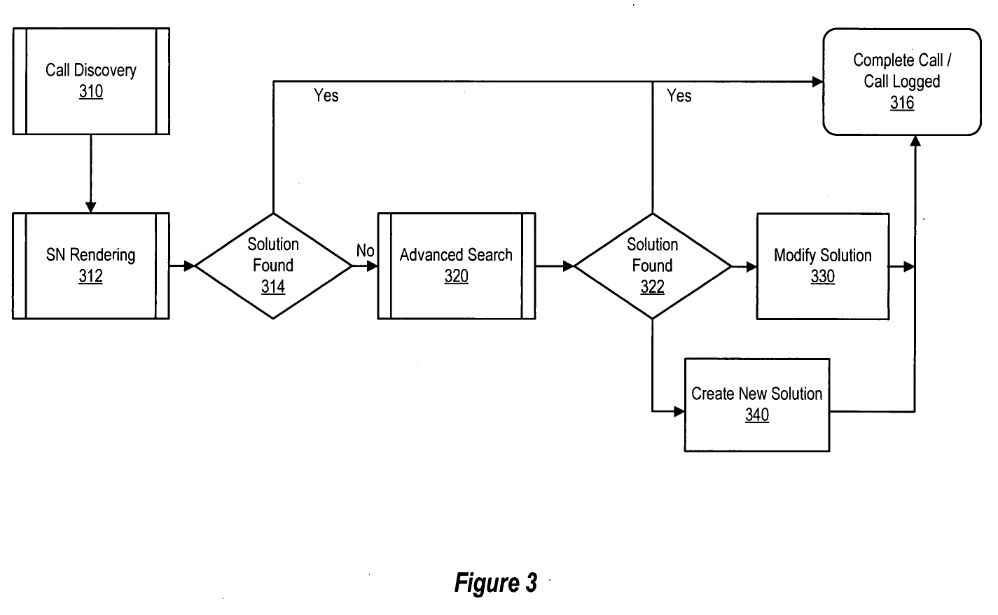

Referring to FIG. 3, a flow chart of the operation of a call in the solution network is shown. More specifically, upon a call discovery 310 (i.e., when a support call is received), the support technician searches the knowledge base for an answer to the customer issue at step 312. The solution network renders a solution if a solution to the issue is found by searching the knowledge base. The technician indicates whether a solution to the issue is rendered at step 314. If the solution was rendered then the technician provides the caller with the solution, completes the call and the call is logged at step 316.

If the answer is not rendered, then the technician uses the advanced search feature to continue to find an answer at step 320. There are three possible results of the advanced search as determined by step 322. The solution may be found as a result of the advanced search, the solution may be found but need to be modified or the solution may not have been found as a result of the advanced search.

If the solution was found based upon the advanced search, then the solution is rendered, the technician provides the caller with the solution, completes the call and the call is logged at step 316. If a similar solution was found but needs modification based upon the advanced search, then the technician modifies the solution while on the call with the caller, provides the caller with the modified solution, at step 330. If a solution was not found based upon the advanced search, then the technician creates a new solution (i.e., creates knowledge) while on the call with the caller, provides the caller with the newly created solution at step 340.

When the technician has used, modified or created the appropriate solution, the technician then closes the call at step 316.

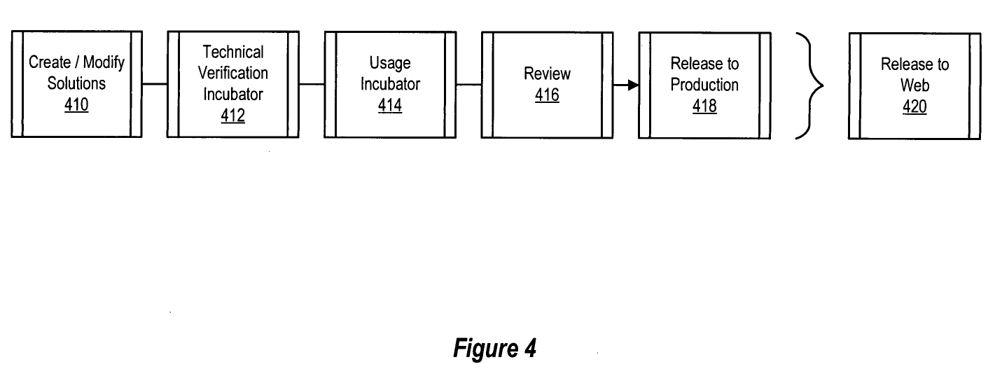

Referring to FIG. 4, a flow chart of the operation of a knowledge management system of the solution network is shown. When solutions are either created (as, e.g., at step 340) or modified (as, e.g., at step 330), then the created or modified solutions are reviewed by the knowledge management system. More specifically, the created or modified solutions are accessed at step 410 and provided to a technical verification incubator at step 412. The technical verification incubator 412 holds the newly generated knowledge to confirm that the customer issue is resolved. When the customer issue is resolved, the knowledge is provided to a usage incubator at step 414. The usage incubator 414 holds the knowledge while the knowledge is used successfully for a time period which is determined by an individual business. The usage incubator 414 assists in controlling the reviewer workload and early warning for escalations. E.g., if a particular component is irregularly accessed (such as a spike in usage), then this may indicate an excursion. After the knowledge successfully completes the usage incubation, then the knowledge is released at review step 416 at which point the content is reviewed by a line of business review team. Each line of business includes its own line of business review team. When a particular line of business review team reviews the knowledge for its line of business, the team makes sure that the knowledge is written correctly both technically and grammatically. A particular line of business review team is most familiar with its own technical product. For example, a user issuing a question may cause the solution network system to render a different solution based upon the line of business of the particular user's system. Additionally, the line of business review team helps in prioritizing which of its line of business solutions to modify first.

After the line of business review team approves the new content, then the content is released to production at step 418. I.e., the content is approved and available to any internal service technician. After the content is released to production, then a legal review is performed if the content is to be released externally and the content is released to the web at step 420.

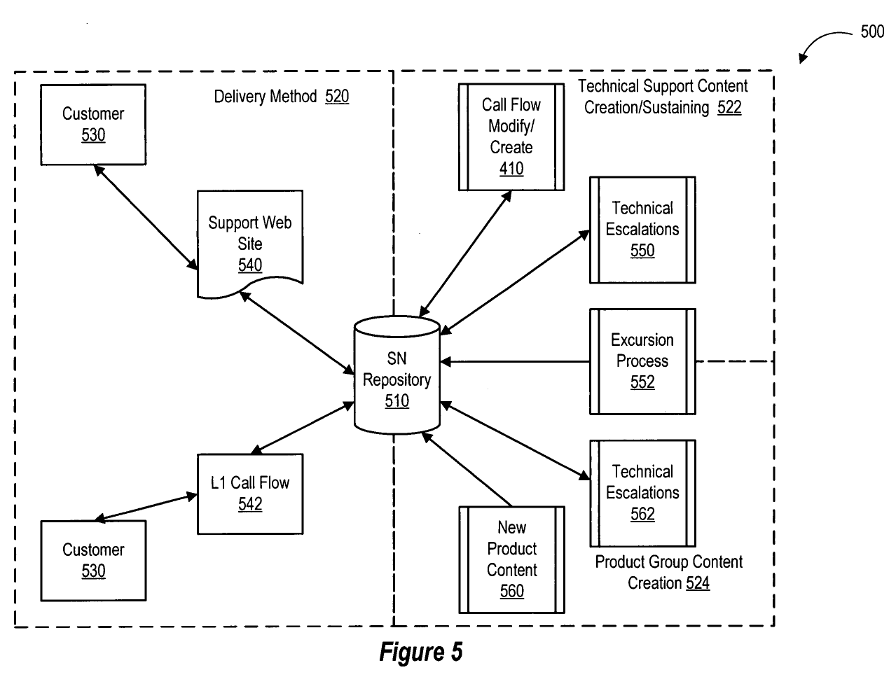

Referring to FIG. 5, a block diagram of a process view of the interaction within the solution network 200 is shown. More specifically, the solution network 200 provides the link between the knowledge delivery portion 520, the technical support content creation/sustaining portion 522 and the product group content creation portion 524.

The solution network 200 is coupled to a customer 530 via a support web site 540 or via a first level of support call flow 542. Call flow within the solution network 200 is tiered. E.g., a first level support technician may receive an initial support call. If this technician can not solve the issue, then the call may be escalated to another more sophisticated technician based upon the difficulty of the issue. The solution network 200 is coupled to the technical support content creation/sustaining portion 522 and more particularly to the call flow modify/create module 410 as well as to a technical escalations module 550 and an excursion process module 552. The solution network 200 is coupled to the product group content creation portion 524 and more particularly to a new product content module 560 and a product group technical escalations module 562 as well as the excursion process module 552.

The technical escalations module 550 enables the escalation of an issue from a first level skill level technician to a second level skill level technician. The escalation enables a skill based routing of the issue based upon questions that have been previously asked of the customer. Upon escalation of an issue, the second level skill level technician may generate or modify a document to address the issue that was escalated. The call flow modify/create module 410 is the module via which the technical support technicians create or sustain content within the solution network 200.

The product group content creation portion 524 is the portion via which product group engineers create content that is provided to the solution network 200. The product group technical escalations module 562 enables the escalation of an issue from a second level skill technician to a product group engineer. The engineer then creates a new document for the issue via the product group content creation portion 524 that is then provided to the solution network 200.

The excursion process module 552 handles exceptions to the solution process at a platform or system level to address when a specific system, a specific component or specific software or some combination of a specific system, specific component and specific software may require a unique solution.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for creating knowledge in a solution network comprising:
generating knowledge for a solution network based upon an interaction with a user of the solution network;
saving the knowledge for the solution network while interacting with the user.

2. The method of claim 1 further comprising:
incubating the knowledge for the solution network before releasing the knowledge for general access.

3. The method of claim 1 further comprising:
augmenting current knowledge while interacting with a user of the solution network.

4. The method of claim 1 further comprising:
providing a self help module within the solution network;
enabling the user to access the self help module to access the knowledge of the solution network; and,
monitoring the user activity while the user is accessing the knowledge of the solution network.

5. The method of claim 4 further comprising:
modifying the knowledge based upon the monitoring.

6. The method of claim 1 further comprising:
storing information relating to customer systems;
linking the information relating to customer systems to the solution network; and,
using the information relating to the customer systems when generating knowledge for the solution network.

7. The method of claim 4 further comprising:
publishing the knowledge for the solution network immediately upon release of the knowledge such that the knowledge for the solution network is available to other users of the solution network as soon as the knowledge is released.

8. The method of claim 4 further comprising:
maintaining a service history on a customer basis;
using the service history to tailor customer specific solutions.

9. The method of claim 1 wherein:
the solution network supports customer systems; and
the customer systems include information handling systems.

10. A system for creating knowledge in a solution network comprising:
means for generating knowledge for a solution network based upon an interaction with a user of the solution network;
means for saving the knowledge for the solution network while interacting with the user.

11. The system of claim 10 further comprising:
means for incubating the knowledge for the solution network before releasing the knowledge for general access.

12. The system of claim 10 further comprising:
means for augmenting current knowledge while interacting with a user of the solution network.

13. The system of claim 10 further comprising:
means for providing a self help module within the solution network;
means for enabling the user to access the self help module to access the knowledge of the solution network; and,
means for monitoring the user activity while the user is accessing the knowledge of the solution network.

14. The system of claim 13 further comprising:
means for modifying the knowledge based upon the monitoring.

15. The system of claim 10 further comprising:
means for storing information relating to customer systems;
means for linking the information relating to customer systems to the solution network; and,
means for using the information relating to the customer systems when generating knowledge for the solution network.

16. The system of claim 13 further comprising:
means for publishing the knowledge for the solution network immediately upon release of the knowledge such that the knowledge for the solution network is available to other users of the solution network as soon as the knowledge is released.

17. The system of claim 13 further comprising:
means for maintaining a service history on a customer basis;
means for using the service history to tailor customer specific solutions.

18. The system of claim 10 wherein:
the solution network supports customer systems; and
the customer systems include information handling systems.

19. A solution network comprising:
a technician interface, the technician interface enabling generating knowledge based upon an interaction with a user of the solution network;
a repository coupled to the technician interface, the repository storing knowledge relating to troubleshooting solutions, the knowledge relating to troubleshooting solutions including the knowledge based upon the interaction with the user, the knowledge based upon the interaction with the user being stored in the repository while interacting with the user; and,
an information broker coupled to the technician interface and to the repository, the information broker determining a best answer for the user based upon information provided by the user.

20. The solution network of claim 19 further comprising:
a customer interface, the customer interface being coupled to the reposityr and to the technician interface, the customer interface providing an interface for a customer to the solution network.

21. The solution network of claim 19 further comprising:
a real time publishing agent, the real time enabling the solution network to release knowledge while the solution network is operating.

22. The solution network of claim 19 further comprising:
an external repository, the external repository storing information relating to customers, the external repository being coupled to the technician interface.

23. The solution network of claim 19 further comprising:
a replacement parts module, the replacement parts module generating solutions relating to which replacement parts are associated with particular systems.

24. The solution network of claim 19 further comprising:
a solution authoring module, the solution authoring module enabling authoring of authored knowledge solutions and applying attributes to the authored knowledge solutions.

25. The solution network of claim 19 further comprising:
a non-solution network content module, the non-solution network content module storing information regarding policies and procedures within the repository.

26. The solution network of claim 19 further comprising:
a decision tree authoring module, the decision tree authoring module linking knowledge in a process oriented manner.
